(19) United States
(12) Patent Application Publication
(10) Pub. No.: US 2022/0206243 A1
(43) Pub. Date: Jun. 30, 2022

(54) LENS DRIVING DEVICE, CAMERA DEVICE AND ELECTRONIC APPARATUS

(71) Applicant: New Shicoh Motor Co., LTD, Zhejiang (CN)

(72) Inventors: Noriyuki WASHIO, Yamato City (JP); Tomoyoshi YANO, Yamato City (JP)

(21) Appl. No.: 17/560,967

(22) Filed: Dec. 23, 2021

(30) Foreign Application Priority Data
Dec. 29, 2020 (CN) 202011605792.7

(51) Int. Cl. G02B 7/02; H04N 5/225

(52) U.S. Cl. CPC G02B 7/022; H04N 5/2254; H04N 5/2257

(57) ABSTRACT

A lens driving device is described that includes a base, a frame having two rising portions rising up from the base and a horizontal portion connecting the two rising portions, and an electric component attached to the frame. An electric wiring electrically connected to the electric component is formed in the frame.

### CROSS-REFERENCE TO RELATED APPLICATIONS

This application claims priority to Chinese Patent Application No. 202011605792.7 filed Dec. 29, 2020, which is hereby incorporated by reference herein in its entirety.

### TECHNICAL FIELD

The present disclosure relates to a lens driving device used in an electronic apparatus such as a smartphone, a camera device, or other type of electronic apparatus.

### BACKGROUND

Some lens driving devices among the lens driving device that have both OIS (Optical Image Stabilizer) function and AF (Auto Focus) function are called periscopic type. In a periscopic lens driving device, a lens body and an image sensor are arranged side by side in a direction orthogonal to the incident direction of light from a subject, and the light from the subject is reflected by a prism or a mirror, transmitted through the lens body, focused on the image sensor, and converted into an image signal by the image sensor. As a document disclosing a technique related to this type of lens driving device, Japanese Patent Application Laid-Open No. 2019-139223A (hereinafter referred to as Patent Document 1) can be given. The lens driving device of Patent Document 1 has a fixed portion, a movable portion, an elastic element, and a driving assembly. The fixed portion has a housing, a base, a frame, and a circuit element. The movable portion has a carrier. The circuit element sends an electric signal, controls a driving assembly, and performs an OIS function and an AF function.

### SUMMARY

However, in the lens driving device of Patent Document 1, a frame was attached to the top surface (upper surface) of the housing of the fixed portion, a magnet for driving in the direction orthogonal to the optical axis was arranged on this frame, and a coil for driving in the direction orthogonal to the optical axis is arranged on the carrier of the movable portion. With such a structure, it is difficult to arrange electric components that require electric wiring on the fixed portion on the top surface side.

The present disclosure has been made in view of such a problem, and present disclosure aims to provide a lens driving device in which an electric component can be arranged at a fixed portion on the upper surface side.

In order to solve the above-described mentioned problem, in accordance with a first aspect of the present disclosure, there is provided a lens driving device including: a base; a frame with two rising portions rising up from the base and a horizontal portion connecting the two rising portions; and an electric component attached to the frame, wherein an electric wiring connected to the electric component is formed in the frame.

In accordance with a second aspect of the present disclosure, there is provided a camera device including the lens driving device described above.

In accordance with a third aspect of the present disclosure, there is provided an electronic apparatus including the camera device described above.

Further features of the present invention will become apparent from the following description of exemplary embodiments (with reference to the attached drawings).

### BRIEF DESCRIPTION OF THE DRAWINGS

FIG. 1 is a front view of a smartphone on which a camera device including a lens driving device according to one embodiment of the present disclosure is mounted;

FIG. 2 is a perspective view of the lens driving device shown in FIG. 1;

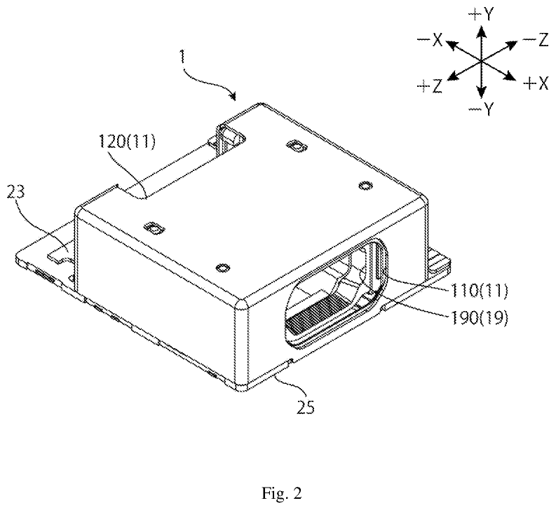

FIG. 3 is an exploded perspective view of the lens driving device shown in FIG. 2;

FIG. 4 is a perspective view in which the case is removed from the lens driving device shown in FIG. 2;

FIG. 5 is a perspective view in which the frame is removed from the lens driving device shown in FIG. 4;

FIG. 6 is a perspective view of the frame shown in FIG. 4; and

FIG. 7 is perspective view showing the inside of a portion on the +Z side in the frame shown in FIG. 6.

### DETAILED DESCRIPTION

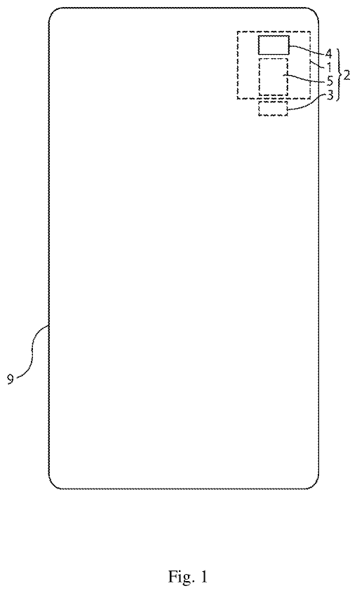

Hereinafter, embodiments of the present disclosure are explained with reference to drawings. As shown in FIG. 1, a camera device 2 including a lens driving device 1 according to one embodiment of the present disclosure is accommodated in a smartphone 9.

The camera device 2 has an image sensor 3, a mirror 4 that reflects light from a subject, a lens body 5 that guides the light reflected by the mirror 4 to the image sensor 3, and a lens driving device 1 that drives the lens body 5.

Hereinafter, a direction in which the light from the subject is incident is appropriately referred to as a Y direction. Further, one direction in which the light reflected by the mirror 4 is directed toward the lens body 5 is referred to as an X direction, and a direction orthogonal to the Y direction and the X direction is referred to as a Z direction. Further, the +Y side may be referred to as an upper side, the −Y side may be referred to as a lower side, the +X side may be referred to as a rear side, the −X side may be referred to as a front side, the +Z side may be referred to as a left side, and the −Z side may be referred to as a right side.

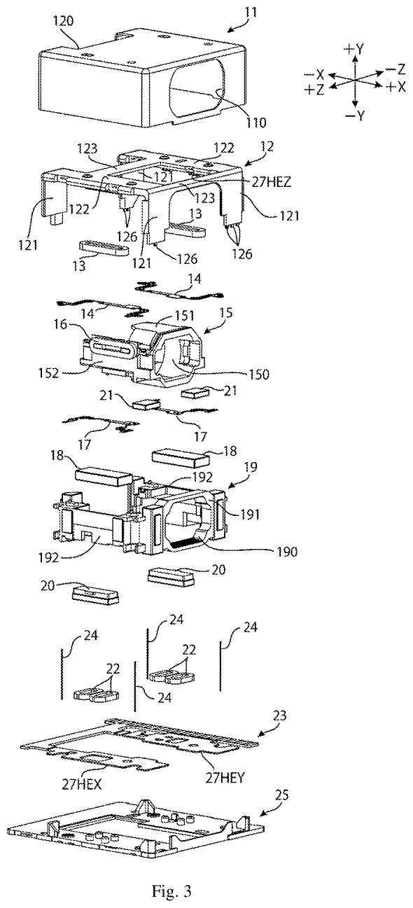

As shown in FIG. 3, the lens driving device 1 has a case 11, frames 12, first coils for OIS (Optical Image Stabilizer) 13, upper side plate springs 14, a carrier 15, second coils for OIS 16, lower side plate springs 17, magnets for OIS 18, a holder 19, magnets for AF (Auto Focus)20, magnets for detection 21, coils for AF (Auto Focus) 22, an FPC (flexible printed circuit board) 23, suspension wires 24, and a base 25. Among these, the carrier 15, the second coils for OIS 16, and the magnets for detection 21 constitute a movable portion. In addition, the magnets for OIS 18, the holder 19, and the magnets for AF 20 constitute an intermediate member. In addition, the case 11, the frames 12, the first coils for OIS 13, the coils for AF 22, the FPC23, and the base 25 constitute a fixed portion.

The movable portion is supported by the holder 19 of the intermediate member via the upper side plate springs 14 and the lower side plate springs 17. The movable portion is movable in the Y direction with respect to the intermediate member. The intermediate member is supported by the base 25 of the fixed portion via the suspension wires 24. The intermediate member together with the movable portion it supports can move in the X direction and the Z direction with respect to the fixed portion. Thus, the movable portion is movable in the X direction, the Y direction and the Z direction with respect to the fixed portion. In addition, the first coils for OIS 13, the second coils for OIS 16, the magnets for OIS 18, the magnets for AF 20, and the coils for AF 22 are driving sources for moving the lens body 5 with respect to the base 25.

The case 11 and the base 25 are combined as a housing. A first opening 110 is provided in the center of the rear side wall of the case 11. A second opening 120 is provided in a portion ranging from the center of the front side wall to the upper side wall of the case 11.

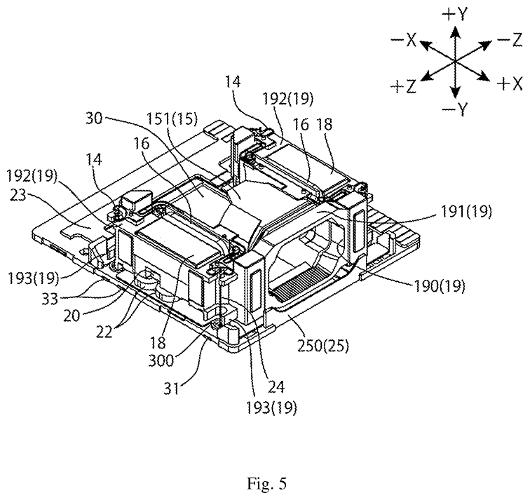

The base 25 is formed by molding the main body of the base 25 with resin in a state where the metal plate member 30, the first metal members 31, 33 are arranged in the resin as shown in FIG. 5. A rising portion 250 rising up to the upper side is provided at an edge on the rear side of the base 25. The FPC23, which is a flexible printed circuit board, is arranged on the base 25.

The metal plate member 30 embedded in the base 25 is thinner than the base 25, and is exposed on the upper and lower sides of the base 25 at a position corresponding to the carrier 15. The end portions of the first metal members 31, 33 are exposed from the end surfaces on the left side and the right side of the base 25. The first metal members 31, 33 embedded in the base 25 have through holes 300. The portions where the through holes 300 of the first metal members 31, 33 are provided are exposed on the upper surface side and the lower surface side of the base 25.

A Hall element 27HEX for X direction detection and a Hall element 27HEY for Y direction detection as electric components are attached to the lower surface of the FPC23. The Hall element 27HEX for X direction detection and the Hall element 27HEY for Y direction detection are accommodated in the accommodation space of the base 25. The coils for AF 22 are provided on the left side and the right side of the upper surface of the FPC23.

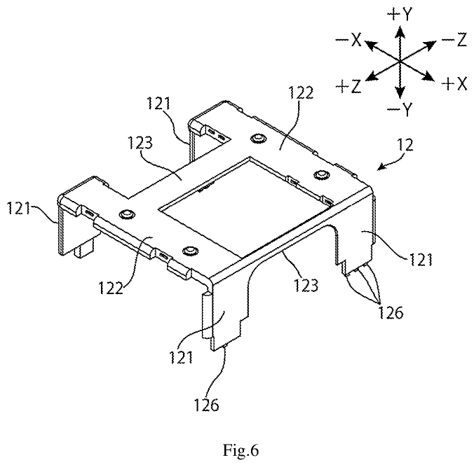

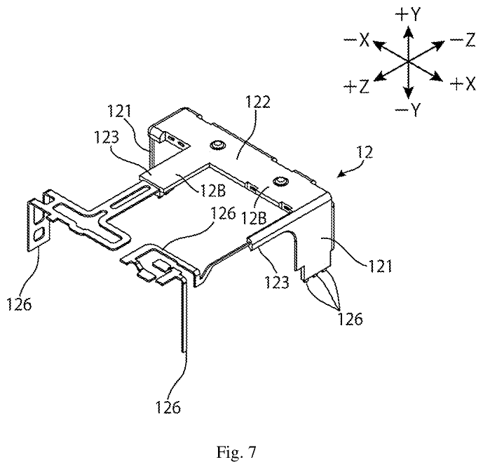

As shown in FIG. 7, the frame 12 is formed by molding the main body 12B of the frame 12 with resin in a state where the second metal members 126 are arranged in the resin. As shown in FIG. 6, the end portions of the second metal members 126 protrude from the lower end portions of the frame 12. The second metal members 126 form electric wirings and serve both for reinforcing the frame 12 and for electric wiring. The lower end portions of the frame 12 are fixed to the base 25. The protruding end portions of the second metal members 126 are electrically connected to the FPC23.

As shown in FIG. 6, the frame 12 has two rising portions 121 rising up from the left side of the base 25, two rising portions 121 rising up from the right side of the base 25, left and right horizontal portions 122 connecting the two rising portions 121 on the left and right respectively, and connection portions 123 connecting the left and right horizontal portions 122. The two rising portions 121 oppose to each other in the optical axis direction. A first coil for OIS 13 and a Hall element 27HEZ for Z direction detection as electric components are provided on the lower surface of the horizontal portion 122 on the right side of the frame 12, and are electrically connected to the second metal member 126, respectively. A first coil for OIS 13 as an electric component is provided on the lower surface of the horizontal portion 122 on the left side of the frame 12, and is electrically connected to the second metal member 126.

As shown in FIG. 7, the second metal members 126 are inserted into the left and right rising portions 121, the horizontal portions 122, and the connection portions 123 of the frame 12. The second metal member 126 has a shape bent along each portion in the frame 12. For example, as shown in FIG. 7, pads for electrically connecting to the first coil for OIS 13 on the left side are formed by two second metal members 126 on the rear side. That is, the second metal members 126 at the connection portion 123 on the rear side serve both the reinforcement of the connection portion 123 and the electrical connection of the first coil for OIS 13 on the left side. The second metal members 126 at the connection portion 123 on the front side have no use for electrical connection, as can be seen from the shape of the loop.

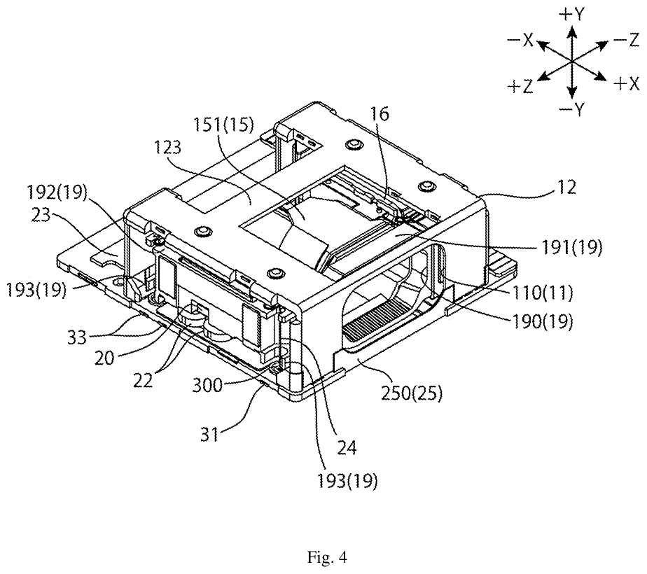

As shown in FIG. 7, each lower end of the rising portions 121 is cut out upward, and this portion is combined with the protruding portion of the base 25 to form a strong coupling structure as shown in FIG. 4. In addition, the connection portion 123 on the rear side is combined with the rising portion 250 of the base 25 to form an opening through which the light from the lens body 5 passes together with the left and right rising portions 121 on the rear side.

As shown in FIG. 5, the holder 19 has a frame portion 191 surrounding the holder opening 190, and first wall portions 192 extending forward from the left and right peripheral portions of the frame portion 191. U-shaped recess portions 193 opened in the Z direction are provided at lower ends of the front, rear, left and right corner portions of the first wall portions 192. A magnet for OIS 18 is provided on the upper surface of the first wall portion 192. A magnet for AF 20 is provided on the lower surface of the first wall portion 192. The upper side plate springs 14 are fixed to the upper surface of the holder 19, and the lower side plate springs 17 (see FIG. 3) are fixed to the lower surface of the holder 19. The upper side plate springs 14 are formed in a wire shape extending while meandering inward from the front, rear, left and right on the upper side of the holder 19. The lower side plate springs 17 are formed in a wire shape extending while meandering inward from the front, rear, left and right on the lower side of the holder 19.

As shown in FIG. 3, the carrier 15 is a lens supporting body that supports the lens body 5. The carrier 15 has a cylindrical body 151 and second wall portions 152 extending forward from the peripheral edge portions on the left side and the right side of the cylindrical body 151. The second wall portions 152 are formed by cutting off the upper side portion and the lower side portion at the front portion of the cylindrical body 151. A through hole 150 is provided in the cylindrical body 151. The through hole 150 and an inner edge portion forming the through hole 150 are an attachment portion of the lens body 5. After the lens driving device 1 is completed, the lens body 5 is fitted into the through hole 150 from between the left and the right second wall portions 152 of the carrier 15 and attached to the carrier 15. The front, rear, left and right of the upper side of the carrier 15 are supported by the upper side plate springs 14, and the front, rear, left and right of the lower side of the carrier 15 are supported by the lower side plate springs 17. The gravity center of the movable portion including the lens body 5 and the carrier 15 that supports the lens body 5 is located approximately at the center of the front, rear, left and right upper side plate springs 14 and the lower side plate springs 17.

The second coils for OIS 16 are provided on the outer surfaces of the left and right second wall portions 152 of the carrier 15. The magnets for detection 21 are provided on the lower surface of the rear portion of the second wall portion 152. In addition, the connection portions 123 of the frames 12 are provided at portions where the upper portion of the cylindrical body 151 is cut off, and the cylindrical body 151 and the connection portions 123 overlap when viewed from the X direction.

As shown in FIG. 5, the suspension wire 24 passes through the U-shaped recess portion 193 of the holder 19, and is bridged between the through hole 300 of the base 25 and the upper side plate spring 14. The lower end of the suspension wire 24 is inserted and soldered to the through hole 300 of the base 25. The upper end of the suspension wire 24 is inserted and soldered to the tip end portion of the upper side plate spring 14 which is formed in a ring shape on the outer side of the holder 19.

The second coil for OIS 16 that constitutes the movable portion and the magnet for OIS 18 that constitutes the intermediate member face each other. When an electric current flows in the second coil for OIS 16, an electromagnetic force in the Y direction is generated in the second coil for OIS 16, and the movable portion moves in the Y direction with respect to the intermediate member. The Hall element 27HEY for Y direction detection detects the magnetic field of the opposing magnet for detection 21 and outputs a signal indicating the detection result. This signal corresponds to the position of the magnet for detection 21 in the Y direction with respect to the Hall element 27HEY for Y direction detection.

The magnet for OIS 18 that constitutes the intermediate member and the first coil for OIS 13 that constitutes the fixed portion face each other. When an electric current flows in the first coil for OIS 13, an electromagnetic force in the Z direction is generated in the first coil for OIS 13 and a reaction force is generated in the magnet for OIS 18. The intermediate member moves in the Z direction with respect to the fixed portion. The Hall element 27HEZ for Z direction detection detects the magnetic field of the opposing magnet for OIS 18 and outputs a signal indicating the detection result. This signal corresponds to the position of the magnet for OIS 18 in the Z direction with respect to the Hall element 27HEZ for Z direction detection.

The magnet for AF 20 that constitutes the intermediate member and the coil for AF 22 that constitutes the fixed portion face each other. When an electric current flows in the coil for AF 22, an electromagnetic force in the X direction is generated in the coil for AF 22, and a reaction force is generated in the magnet for AF 20. The intermediate member moves in the X direction with respect to the fixed portion. The Hall element 27HEX for X direction detection detects the magnetic field of the opposing magnet for AF 20 and outputs a signal indicating the detection result. This signal corresponds to the position of the magnet for AF 20 in the X direction with respect to the Hall element 27HEX for X direction detection.

The above are the details of the configuration of the present embodiment. The lens driving device 1 according to the present embodiment includes: a base 25; two rising portions 121 rising up from the base 25; frames 12 with horizontal portions 122 connecting the two rising portions 121; and first coils for OIS 13 and Hall element 27HEZ for Z direction detection as electric components attached to the frame 12. The second metal members 126 as electric wirings connected to the electric components are formed in the frames 12. Since the electric wirings are formed in the U-shaped frames 12, it is possible to bring the electric components at the fixed portion on the upper surface side into conduction with respect to the second metal members 126.

Therefore, it is possible to provide a lens driving device 1 in which the electric components can be arranged at the fixed portion on the upper surface side.

It is to be noted that in the above embodiment, the frames 12 on the left and right of the carrier 15 may not be connected by the connection portions 123, but the respective frames 12 may be provided on the left and right. At this time, the frames 12 provided on the left and right sides of the carrier 15 may have the same structure. It can be manufactured without worrying about whether it is for the left side or the right side. In addition, the frame 12 may be provided only on the left or the right of the carrier 15. In addition, two rising portions 121 of the frame 12 may face each other in the direction orthogonal to the optical axis direction. In addition, the electric components may be provided on the rising portion 121 of the frame 12.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A lens driving device comprising:
a base;
a frame with two rising portions rising up from the base and a horizontal portion connecting the two rising portions; and
an electric component attached to the frame,
wherein an electric wiring electrically connected to the electric component is formed in the frame.

2. The lens driving device according to claim 1, wherein a main body of the frame is made of resin, and the resin covers a metal member constituting the electric wiring in the frame.

3. The lens driving device according to claim 1, wherein the two rising portions oppose to each other in an optical axis direction of a lens body.

4. The lens driving device according to claim 1, comprising a carrier with an attachment portion for attaching a lens body, wherein the rising portions of the frame are provided on a left side and a right side of the carrier.

5. The lens driving device according to claim 4, comprising a connection portion connecting horizontal portions of the frame on the left side and the right side.

6. The lens driving device according to claim 5, wherein the connection portion is formed by covering the metal member with resin.

7. The lens driving device according to claim 5, wherein the carrier has a shape in which an upper side portion is cut off at a front portion of a cylindrical body, and the connection portion is provided in this cut portion.

8. The lens driving device according to claim 4, wherein the rising portions of the frame provided on the left side and the right side of the carrier have the same structure.

9. A camera device comprising the lens driving device of claim 1.

10. An electronic apparatus comprising the camera device of claim 9.
